(19) United States
(12) Patent Application Publication
(10) Pub. No.: US 2011/0313579 A1
(43) Pub. Date: Dec. 22, 2011

(54) Method for Energy Saving On Electrical Systems Using Habit Oriented Control

(76) Inventor: Cheuk Ting Ling, Central (HK)

(21) Appl. No.: 13/110,069

(22) Filed: May 18, 2011

(30) Foreign Application Priority Data
May 25, 2010 (HK) HK1139829A

(51) Int. Cl. G06F 1/26

(52) U.S. Cl. 700/291

(57) ABSTRACT

Habit-oriented control of an electrical system. A temporal habit pattern is generated based on past environmental parameters captured by sensors, past user feedback input from a user interface, or past user commands input from the user interface. The temporal habit pattern is stored. The temporal habit pattern is compared with current environmental parameters captured by sensors or current user feedback input from the user interface. The electrical system is driven so as to optimize energy saving based on deviation of current user status and current environmental parameters from the temporal habit pattern. Generating the temporal habit pattern may include challenging user habit by tuning the temporal habit pattern to values for which the electrical system consumes less energy.

### BACKGROUND OF THE INVENTION

1. Field of the Invention

The invention relates generally to methods and apparatuses for energy saving on electrical systems and, in particular, to generating user habit patterns and adapting the driving of electrical systems with respect to environmental parameters to optimize energy saving.

2. Description of Related Art

Over a hundred years of electrical air conditioning unit history, the appliance makes huge changes on Human life quality (a comfort temperature around us), but also huge demand on Electricity, eventually exhausting our nature resources. However, the more energy burned, the hotter the environment is, the more frequent turning our Air Conditioner on, and eventually turn our Air Conditioner ON more frequently, and this negative loop burns our Earth up.

The present Invention is to make a balance between Life Quality and Energy Saving on existing Air Conditioning System, before a new revolution and technology on Temperature Conditioning available. The current Air Conditioning System has a number of areas can be improved:

a. The way to control the on/off time and threshold of air cooling: Most AC system, its power control is manually controlled either via the switch when the instant need, or via the timer configured by user for the fixed schedule; and similar practice applies on the air cooling threshold, the Level of Comfort—temperature threshold in degree and humidity threshold in relative percentage. However, due to the user convenience, most users prefer to keep the AC ON and/or at Cooling at over-cool state, as being lazy to go to the AC or picking up AC remote, to make the status change time to time. The mode is always ‘Over’, makes AC significant wastage on Energy usage; here we name the mode of lazy-habit.

b. The design of the Air intake and the Air flow out: Most Air Conditioning Appliances used in residential, the port or window for its Air intake (warm air) and Air outlet (cool air) are next each other making the cooling circulation localized, results inefficiency of heat exchange at the compressor, and slows down the cooling rate for the target area.

c. The feeling of ‘Hot’ to Human: In most case, air conditioning is for Mankind, to let his or her feeling of Hotness go away, especially in the direction from top down, instead of bottom up. Using traditional residential Air Conditioning Appliance, users normally have to wait the cooling zone extend to reach user, in order to let user feel cooling. This way requires the appliance to cool extra space and consume more cooling energy.

d. The effective way to ventilating cool Air: Although the electric Fan does not make the air cool down, it provides a very good air circulation job, in most environment friendly user, mixes the use of Air cooling and Fan circulation to provide better cool air ventilating, the Fan blows away the hot air surrounding, this makes the feeling of ‘Hot’ significantly reduced. However most existing Air Conditioning unit, air flow rate is by the Unit's air compressor fan. In most case the air flow rate and control of direction are far less powerful and flexible than most electric Fans provided. Hence simply use Air Conditioner's Fan for air circulation will slow down the cooling purpose. Another interesting point is simply the use of Air conditioning, to make every user meet his/her temperature cool down requirement, the result normally makes the overall living/working space cold easily, that not only wastes the Energy for cooling, but also contradicting the principle of User Health and the term of comfort environment.

### BRIEF SUMMARY OF THE INVENTION

It is the object of the present invention to overcome or substantially ameliorated at least one of the above disadvantages and to provide improved methods and apparatuses for controlling electrical systems such as air conditioning systems that optimize energy saving based on habit oriented control.

The present Invention provides apparatus and methods for maximizing the performance of existing Air Conditioning Unit, by adapting User's Habit, both the time usage and the level of comfort, are formulated into Habit pattern. System utilizes the Habit pattern to modulate the Air cooling and Fan circulation, to achieve Energy Saving purpose while maintaining quality of life, the demand of indoor air cooling purposes. The system comprises at least one Central Processing Unit (CPU), connects Real-time Clock (RTC) and is coupled through various Input and Output (IO), such as the environmental Sensors (SENSOR), the electrical Power Switches (SW), the Infrared Module (IR), the RF Module (RF) and Display Panel (DISPLAY) through wired or wireless connection. The Power Switches and the Infrared Module are arranged to control Air Conditioner (AC) and Electrical Fan (FAN).

The system according to an embodiment of the present Invention, continuously monitors user status of Present, via the use of sensor like Passive Infrared (PIR) or other Optical, in the targeted living room or working area, and also senses the need of user feedback on their level of comfort with respect to the current Temperature and Humidity. Feedback of level-of-comfort is the given from sensor like buttons, or detector for user-being, the behavior representation came to standstill in front of the AC or the FAN sustainedly to indicate he/she need additional cooling request. Sensors are located at the position where user can reach or best for detect, wire or wirelessly using RF, and multiple installations can be used for inter-calibration and distributed monitoring.

In an embodiment of the present Invention, System CPU uses the real-time clock, captures sensory inputs, the status of User Present, Level of Comfort with respect to time, then formulates into Habit Pattern, a serial binary representation. With daily operation, the CPU adapts user behavior preference with respect to temporal changes of environment (Temperature and Humidity) into Habit Pattern. This Pattern will be used in the System as the starting point to estimate appropriate operation control to external device, the Power PWM Switching to AC and FAN. Besides, the program in CPU provokes user into an energy saver, by slowly address the temperature preference to 25.5 degrees Celsius, if the program anticipate continuous low temperature request is not likely required. This makes the whole system self-balance into a state of having comfort air conditioning and energy saving purpose.

In the I/O control system according to the an embodiment of present Invention, the system incorporates current Environment data and Habit Pattern to manipulate a suitable figure, which modulates the PWM switching of AC ON/OFF for adjusting the Cooling Air generation and the PWM switching of FAN ON/OFF for the Cooled Air circulation.

According to an aspect of the present invention, there is provided a method for habit oriented control in electrical systems. The method comprises the steps of: generating a temporal habit pattern, based on past environmental parameters captured by sensors, past user feedback input from user interface or past user commands input from user interface; storing said temporal habit pattern; comparing said temporal habit pattern against current environmental parameters captured by sensors or current user feedback input from user interface; and determining the driving of an electrical system to optimize energy saving based on the deviation of current user status and current environmental parameters from said temporal habit pattern.

Advantageously, the step of generating a temporal habit pattern may further comprise the steps of: initializing said temporal habit pattern based on default values; updating the values of said temporal habit pattern to align with user feedback or user commands on a periodic basis.

The step of generating a temporal habit pattern may further include the step of challenging user habit by tuning said temporal habit pattern to values for which the electical system consumes less energy.

The step of generating a temporal habit pattern may further comprise the step of equalizing the values of said temporal habit pattern by averaging adjacent values in the time domain of said temporal habit pattern.

The temporal habit pattern may represent the presence of user before said electrical system. The default value preferrably ranges from 0 to 16; said updating the values of said temporal habit pattern may be carried out by the equation:

Present(t)=Present′(t)*Pscale+Poffset
where Present(t) represents the presence of user at time slot t and ranges from 0 to 16;
Present′(t) represents the historical presence of user at time slot t and ranges from 0 to 16;
Pscale represents the scaling factor which ranges from 1 to 2 if user is present at time slot t, and ranges from 0 to 1 if user is absent at time slot t;
Poffset represents the offset value which ranges from 0 to 16 if user is present at time slot t, and ranges from 0 to 1 if user is absent at time slot t.

The temporal habit pattern may represent the presence of user before said electrical system, and said equalizing the values of said temporal habit pattern may be carried out by the equation:

Present(t)=Present′(t−1)*scale1+Present′(t)*scale2+Present′(t+1)*scale3+offset
where Present(t) represents the presence of user at time slot t and ranges from 0 to 16;
Present′(t) represents the historical presence of user at time slot t and ranges from 0 to 16;
scale1, scale2, scale3 range from 0.01 to 0.99;
offset ranges from 0.01 to 10.

According to another aspect of the present invention, the electrical system may be an air-conditioning system, and said temporal habit pattern may represent the temperature level of comfort. The default value preferrably ranges from 20 to 35; and said updating the values of said temporal habit pattern may be carried out by the equation:

LOC_{—}t(t)=LOC_{—}t′(t)*Tscale+Toffset
where LOC_t(t) represents the temperature level of comfort at time slot t and ranges from 20 to 35;
LOC_t′(t) represents the historical temperature level of comfort at time slot t and ranges from 20 to 35;
Tscale represents the scaling factor which ranges from 0.5 to 1.9;
Toffset represents the offset value which ranges from +0.1 to +0.9 if user feedbacks too cold at time slot t, and ranges from −0.1 to −0.9 if user feedbacks too hot at time slot t.

Advantageously, said challenging user habit may further comprise the steps of: determining the minimum value Lm of the termperature level of comfort curve LOC_t′(t); marking up values in termperature level of comfort curve which are less than (Lm*Mscale1) for at least 4 continuous values; and replacing the marked up values in said temperature level of comfort curve by applying the equation:

LOC_{—}t(t)=LOC_{—}t′(t)*Mscale
where Mscale and Mscale1 range from 0.1 to 1.9.

Where the temporal habit pattern represents the temperature level of comfort, said equalizing the values of said temporal habit pattern may be carried out by the equation:

LOC_{—}t(t)=LOC_{—}t′(t−1)*scale1+LOC_{—}t′(t)*scale2+LOC_{—}t′(t+1)*scale3+offset
where LOC_t(t) represents the temperature level of comfort at time slot t and ranges from 20 to 35;
LOC_t′(t) represents the historical temperature level of comfort at time slot t and ranges from 20 to 35;
scale1, scale2, scale3 range from 0.01 to 0.99;
offset ranges from 0.01 to 10.

The temporal habit pattern may also represent the humidity level of comfort, said default value preferrably ranges from 46 to 98; and said updating the values of said temporal habit pattern may be carried out by the equation:

LOC_{—}h(t)=LOC_{—}h′(t)*Hscale+Hoffset
where LOC_h(t) represents the humidity level of comfort at time slot t and ranges from 46 to 98;
LOC_h′(t) represents the historical humidity level of comfort at time slot t and ranges from 46 to 98;
Hscale represents the scaling factor which ranges from 0.5 to 1.9;
Hoffset represents the offset value which ranges from +1 to +9 if LOC′t(t)<20 and user feedbacks too cold at time slot t, and ranges from −1 to −9 if user feedbacks too hot at time slot t.

Where the temporal habit pattern represents the humidity level of comfort, the equalizing the values of said temporal habit pattern may also be carried out by the equation:

LOC_{—}h(t)=LOC_{—}h′(t−1)*scale1+LOC_{—}h′(t)*scale2+LOC_{—}h′(t+1)*scale3+offset
where LOC_h(t) represents the humidity level of comfort at time slot t and ranges from 46 to 98;
LOC_h′(t) represents the historical humiditylevel of comfort at time slot t and ranges from 46 to 98;
scale1, scale2, scale3 range from 0.01 to 0.99;
offset ranges from 0.01 to 10.

The driving of said electrical system may be performed by various modes of switch modulation.

Advantageously, the method for habit oriented control in electrical systems may further comprise the step of displaying information of energy saving with respect to the usage of said electrical system. The sensors may be arranged at one or more locations, and are in communication with said electrical system via wired or wireless connections. The user feedback input may comprise sensor input in response to the user being present before said sensor for predetermined period of time, indicating positive user request of service from said electrical system.

According to a further aspect of the present invention, the electrical system may be a lighting system. The environmental parameters may include illumination condition with resepct to time and location. The temporal habit pattern may represent user activities with respect to different time and different day of the week, and wherein said driving of said lighting system may provide required level of illumination and may optimize energy saving.

### BRIEF DESCRIPTION OF THE DRAWINGS

One or more embodiments are described hereinafter, by way of example only, with reference to the accompanying drawings in which:

FIG. 1 is its functional block diagram illustrating the connectivity between the CPU, the Memory, the Real-Time-Clock (RTC), the Sensory and controlled electrical devices (AC and FAN), according to embodiments of the invention.

FIG. 2, 3, 4 illustrate three different usages from the present Invention.

FIG. 2 is one of the possible usages that split the CPU into Central Processing Unit and Assistant Processing Unit, where the key-processing unit is located close to the controlled device.

FIGS. 3 & 4 are another possible usages that the key-processing unit is located close to remote Sensory that can control multiple electrical devices at different zone, according to embodiments of the invention.

FIG. 5 is the tree diagram, illustrating how the present Invention, interprets user Behavior—Habit, handles the status of user Present, the temporal changes of environment, calculates and adapts into Habit Pattern—Knowledge, then controls external I/O devices—Reaction.

FIGS. 6 & 7 is the graphical representation on how CPU learnt from User Status and Environment Data, on top of the Template according to embodiments of the invention.

FIG. 6 is a high-level representative graph plot to tell how User feedback influences the Habit Pattern.

FIG. 7 is an example, describes how the Pattern adapts temporal changes of Level of Comfort feedback, (701) and (710) show the curve response to continuous changes from User input, while (701) and (704) are when no more changes are found, and the curve is doing self-stabilizing as time being.

FIG. 8 is the graphical representation on how CPU updates historical record of User Present or Device Usage, according to embodiments of the invention. The graphic explain how the historical pattern and current monitored status are interpreted and calculated into updated pattern for the Operation to be taken with respect to time, 7 days 24 hours a day. The diagram also includes the handling of “no show” (817), “new entry” (815), “Quick Cool” (818) and “Pre Cool” (820) required.

FIGS. 9, 10, 11 & 12 are a flow chart of a method how CPU captures data from Sensory, digests into Habit Pattern store at the Memory, the way of calculating the Prediction, the way of Guessing user Behavior, the self pattern adjustment, and the controlling SW for external devices, according to embodiments of the invention.

FIG. 9 is the main flow of the logic decision operated periodically to maintain the system.

FIG. 10 shows the flow of Prediction.

FIG. 11 explains how it handles the temporal changes like user Gesture as kind of service request.

FIG. 12 explains how the Invention anticipates user behavior.

FIG. 13 is the diagram of Operation Model, Aggressive/Balance/Conservative, and Sleeping Model, how they portion the switching-on duration for AC and FAN, at different time, mentioned according to embodiments of the invention.

FIG. 14 is the table of Energy Saving Profile, the AIR/FAN PWM switching pattern against various switching operation (OpMode), according to embodiments of the invention.

FIG. 15 illustrates operational principle of Energy Saving using the AC/FAN switch modulation according to embodiments of the invention. It explains the energy benefit of using PWM switching and additional Fan for widespread of air circulation.

FIG. 16 is the diagram, explains existing residential AC area can be improved by additional Fan for air circulation. The upper (1601˜1604) is the traditional AC unit that having short air circulation zone, and lower (1605˜10) is the widespread air circulation zone by separating the air intake and outlet, and additional fan for wider air stream.

FIG. 17 is the graphically representation of Input and Output, recorded from the software stimulation. It gives an insight how temporal changes of environment can be adapted by suitable modulation of control of air conditioning devices. Also it shows a significant energy saving while maintaining level of comfort.

FIG. 18 is the stimulation result; it estimates the figure of Energy usage with and without using the Invention.

### DESCRIPTION OF PREFERRED EMBODIMENTS

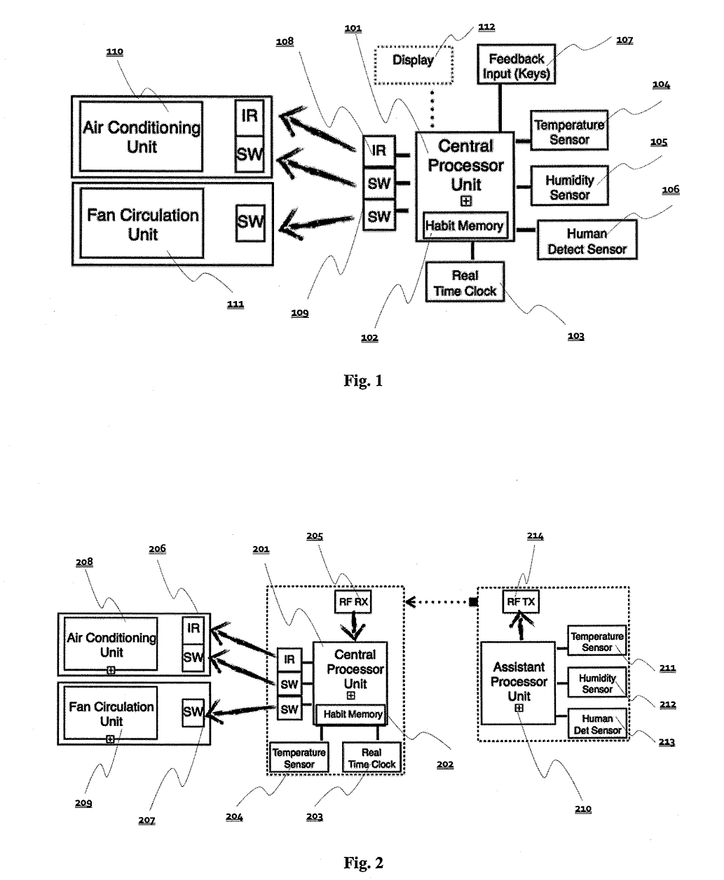

The present Invention provides apparatus and methods for maximize the performance of existing Air Conditioning Unit, by utilizing the modulation of Air cooling and Fan circulation, achieves Energy Saving purpose while maintaining the quality of life, the demand of indoor air cooling purposes. In FIG. 1, illustration shows the system and block diagram of the present Invention, comprising (i) a Sensory unit to detect the activity of User and changes of Environment, like User the Present (106), the comfort level feedback (107), the current Temperature (104) and Humidity (105), (ii) a Memory system (102) to store formulated Habit Pattern, a plurality of types of binary sets comprising a series of binary representing the User Present and Level of Comfort preference, (iii) a Control to external air conditioning devices means, which takes sensory input indicating current User and Environmental status, calculates with the historical User Present and Level of Comfort preference, generates specific figure, representing the mode of switch modulation (ON/OFF) to external control device, like air conditioning devices (110) and air circulation devices (111), over the wire or the wireless interface, to electrical power switch SW (109) or infrared control switch IR (108), and (iv) a Processing unit CPU (101) is to process and store user habit, the timely User usage and level of comfort preference, with respect to time via the Real Time Clock RTC (103), into Habit Pattern.

Structure of the Habit Pattern (HB) in the present Invention interprets as a process to collaborate irregular Signal and Activity (S&A), like the Present or Usage, the Level of Comfort in terms of Temperature and Humidity range, into a regular behavior pattern of User. The present Invented method is not only the pattern formulation from user and environment inputs, but also the knowledge of behavior handling, and Action Response (AR) of its Hidden Intention (HI). The term collaborate irregular Signal and Activity, it comprises of the process of the ability to create new entry for new behavior, the ability to adapt into recorded behavior and the ability to diminish less frequent behavior record.

In the application of Air Conditioning using Habit oriented control, the system will be modeled into

[S&A, HI, RA, HB]

### Where

Signal/Activity (S&A) is divided into (i) the user action, like the action of Enter/Exit, the press of key sensors, (ii) the movement detected, like standstill or walking close to, and (ii) the environment information, like local temperature figure and local humidity percentage;
Hidden Intention (HI), are defined into “Too hot, turn on the system for quick cool”, “Still not cool enough, expect further lower the room temperature”, “Kept as is”, “Too humid, requires better air circulation and compressor to reduce the humidity”, “Over cooling, as the room no longer crowd as before, shut the cooling”, and “Turn off the cooling, although the room temperature above 25.5 degree C., as for Health issue”.
Response Action (RA) for air conditioning will be the PWM control of ON and OFF of cooling device, like Air Conditioner and ventilation system or air circulation system, like Electric Fan;
Habit Pattern, is the curve describing how User behaves on S&A, HI, and RA at different scenario and time frame, it will be a set of continuous figures with respect to time, for the system to calculate and predict most possible RA.

Formation of the Habit Pattern, it is a plurality of types of binary sets comprising a series of binary representing the User Present and Level of Comfort preference. Each binary set is created on user's new activity or updated with user's feedback, with respect to time. For example, User enters to a room at Friday 7:45 pm (Signal and Activity, transition from Stay-exit to Entry, is given from corresponding sensor), the system checks any history of usage in time slot 7:45 pm Friday, if that is new to the system, creates new ‘Entry’ record at this time slot, assigns with initial values for Present and Level-of-Comfort, which is used for calculation the possibility of next ‘Entry’ and room's temperature adjustment at the next same occasion. Based on the calculated result, the system uses the current room temperature/humidity and the assigned initial value of Level-of-Comfort, to assign the record's Hidden Intention as ‘Quick-cool’ or ‘Stay-as-is’. And fmally the Action Response will be based on the Hidden Intention, maps to the corresponding PWM switching control to external devices for Air cooling and circulation. For the next week at the same time slot, if User is present and feels the current room environment can not meet user's level of comfort, user behavior is feedback. And the system quickly address this need by asking Action Response to control external devices for necessary conditioning adjustment; and then slightly adjust the values of Level-of-Comfort in the Habit Pattern, to prepare for next similar scenario. Also for the case, if user is not present at the right time, the system will calculate the figure representing the user Present, whether it is required any pre-air-circulation for scheduled User-Entry. Besides, system built-in an inner process, monitors the trend of the Pattern, to avoid over conditioning (in Air Conditioning Application, it is over cooling). This is done by detecting the curve of Level-of-Comfort, is staying at over-cool condition continuous, like continuous ‘N’ time slots, the system will adjust the last time slot figure (#N) slightly towards to normal direction; together with another averaging mechanism (taking the calculation of two adjacent records), these two operations rectify mankind's lazy-habit on the balance of Comfort and Energy-Saving.

In summary, Habit Pattern Formation and maintenance includes four steps:

### The Creation:

Present(t)=0.1

Level-of-Comfort for temperature and humidity, LOC_t(t)=25.5; LOC_h(t)=62;

### The Adjustment on User Feedback:

Present(t)=Present′(t)*1.3+0.1, for user present again at the same time slot
=Present′(t)*0.7+0.0, for user absent at the scheduled present time slot
remark: Present(t) saturated at value of 16

LOC_t(t)=LOC_t′(t)*1.0+0.5, for detect user response too cold
=LOC_t′(t)*1.0−0.5, for detect user response too hot
remark: LOC_t(t) saturated at value of upper limit of 35, and lower limit of 20

LOC_h(t)=LOC_h′(t)*1.0+4.0, for LOC_t′(t)<20 & detect user response too Cold
=LOC_h′(t)*1.0−4.0, for LOC _t′(t)>35 & detect user response too hot
remark: LOC_h(t) saturated at value of upper limit of 98, and lower limit of 46

### The Stimulation or Challenge:

Present(t): Not applicable

LOC_t(t): Detect and Challenge steps as below
a. Scan through the LOC_t, search the lowest point of the curve, and take it as minimum (Lm);
b. Use Lt=Lm*1.1, re-scan to mark-up all 4 or more continuous records whose value below Lt
c. At every mark-up, take last record (t) value below Lt, and adjust LOC_t(t)=LOC_t(t)*1.1

LOC_h(t): Not applicable

### The Averaging:

Present(t)=Present′(t−1)*0.16+Present′(t)*0.68+Present′(t+1)*0.16 remark: Present(t) saturated at value of 16

LOC_t(t)=LOC_t′(t−1)*0.33+LOC_t′(t)*0.33+LOC_t′(t+1)*0.33 remark: LOC_t(t) saturated at value of upper limit of 35, and lower limit of 20

LOC_h(t)=LOC_h′(t−1)*0.33+LOC_h′(t)*0.33+LOC_h′(t+1)*0.33 remark: LOC_h(t) saturated at value of upper limit of 98, and lower limit of 46

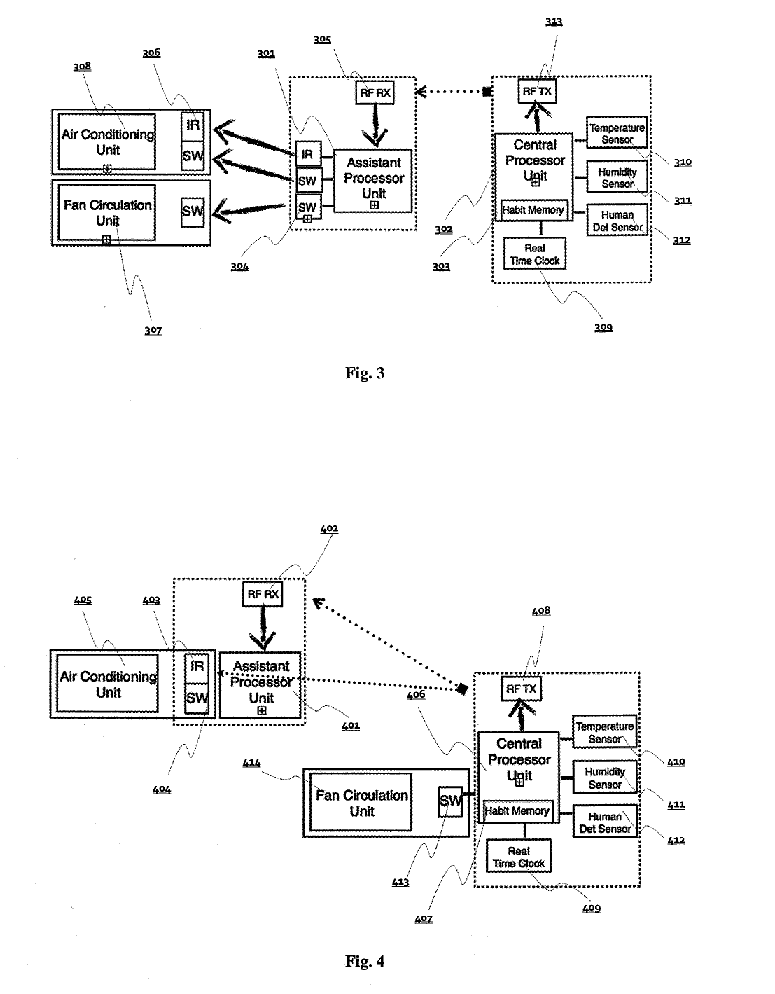

A Habit oriented control system can have various configuration for different Application usage. Like FIG. 1 is an all-in-one configuration, which could be built totally inside the product. FIG. 2 is a scenario that the Central Processing Unit is separated into one Central Processor Unit (201) with Memory (202) and Assistant Processor Unit (210), which is mutually communicated over the wire or the wireless RF (205,214); this arrangement allows Air Conditioning Unit (208) and Fan Circulation Unit (209) close to the Central Processor via the connection to Switch (207) and/or IR (206). With fetch single or multiple sensory (211, 212, 213 & 204) input locally and remotely, better air conditioning is calibrated on temporal changes for User's need. There is another scenario like FIG. 3, the Central Processor is located far from the controlled appliance; with this configuration, a single remote Central Processing Unit (302) house the RTC (309), the Sensory (310, 311, 312), the Habit Memory (303), with the processed Habit Pattern, over the RF (305, 313) can control multiple target Appliance, like Air Conditioning Unit AC (308) and Air Circulation Unit FAN (307) at different zones; in this case the Assistant Processor Unit (301) may usually implement inside the Electrical Switch (304, 306) to be used by the AC and FAN. And FIG. 4 is an embedded solution, integrating the Central Processor (406) into the Electric Fan or Air-Circulation Unit (414) with possible Assistant Processor integrated (401), the integrated Unit will have RF (408-402) or IR (408-403,404) port to control nearby Air-Conditioner (405) for necessary air cooling control. Similar to FIGS. 2 and 3, Temperature sensor (410), Humidity sensor (411), Human detect sensor (412), Real-time clock (409) and Habit Memory (407) are all required, the control between Central Processor and the Fan Circulation Unit is the switch, like Tri-electrode ac switch—Triac (413).

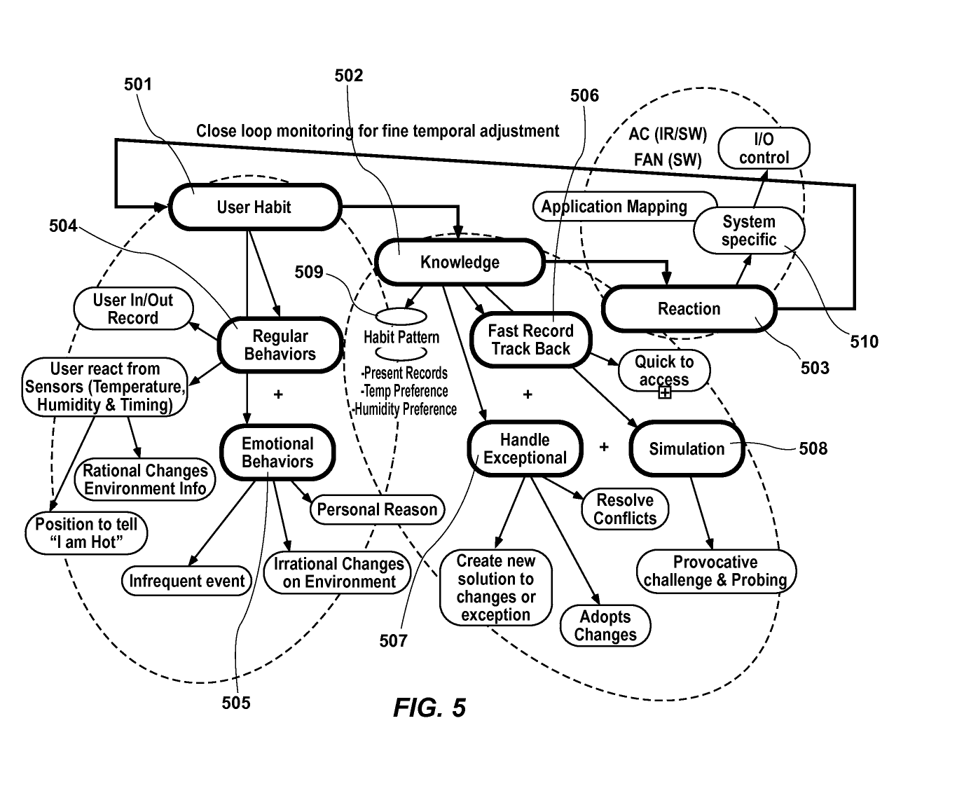

To understand how Habit Pattern adapted for User behavior and Changes of Environment, FIG. 5 illustrates tree diagram explaining the nature and characteristic of the present Invention. The Invention divides “User Habit” (501) or Behavior into Regular (504) and Emotional (505). For the use of Air Conditioning, the Regular-Behavior includes the IN/OUT record and the User reaction from the temporal changes of environment. In this behavior, the Temperature and Humidity are the key factors influence his or her usage of air conditioning, they are rational and likely can be recognized by kind of Hidden Intention, like (a) standing in front of the cool air outlet, to tell the User feeling “Hot” and expect further cooling and better circulation, (b) detecting User movement at Bedroom, can tell the User feeling “Too cold or Still hot”, and expect adjustment of air temperature and circulation. Another type of Behavior is Emotional or unexpected, its Hidden Intention like (a) personal reason—User gets sick, requests abnormal changes to air conditioning, (b) infrequent event—group of new users enter the room, demanding additional conditioning on room's temperature and air circulation, and (c) irrational changes on Environment—Steam Cooking indoor makes additional conditioning required.

Once those inputs are captured via sensory, the data is proceeded to the stage of “Knowledge” (502). At this stage, the system handles three different topics but converged into Habit Pattern (509), which this pattern is used for system's Response Action (503), the control to external electrical devices. Those topics are, (a) the ‘Historical record track-back’ (506), to find any similar handling done in the past and trying to apply into current scenario; (b) the ‘Exceptional’ (507) targets to resolve conflict, adapt changes and create new entry of scenario; and (c) the ‘Stimulation’ (508), is to challenge the existing curve of Habit Pattern (509), whether it is good enough to have balance between Level of Comfort and Energy Saving purposes.

The “Reaction” 503) or Response Action (RA), is how the system controls the external devices based on the User Intention and Environmental changes. For the air conditioning case (510), it is to control the power switching of the AC and the FAN, provides necessary air conditioning. For different application, the Habit oriented control in this mapping will be different, like on Lighting application, the control will be focus on the brightness via its turn on/off modulation, for the need of auto-lighting, lighting romance and energy saving purpose;

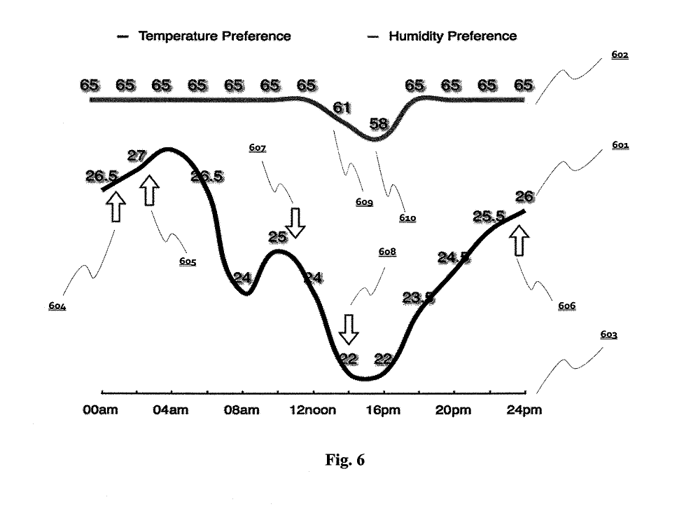

FIG. 6 illustrates how User adjusts the temperature preference (601), with respect to time—24 hours (603), devised from the Habit Pattern, so that the program will base on the delta of temperature preference and current room temperature to give the best conditioning for User. In order to avoid dynamic changes of the Temperature Preference, each time slot can have only incremented (604, 605, 606) or decrement (607, 608) by 0.5 degrees Celsius a day, which 0.5 degrees Celsius may insufficient to provide best comfort, hence the system will temporary provide either quick-cooling or stop-cooling operation, so that to address the instant need for the User. With daily operation, this curve adapts User behavior to a better comfort environment while consumes less energy. On Humidity Preference (602), another component devised from the Habit Pattern, will be adjusted by monitoring the temperature preference changes. System monitors substantially changes on temperature preference. If the request of additional air-cooling continuous receives at 20 degrees Celsius, the humidity preference will be lower by 4% (609, 610). And similarly, for another extreme corner, the request of stop-air-cooling continuous receive at 35 degrees Celsius, the humidity preference will be higher by 4%, until humidity preference is saturated at 98% at top and 46% at bottom.

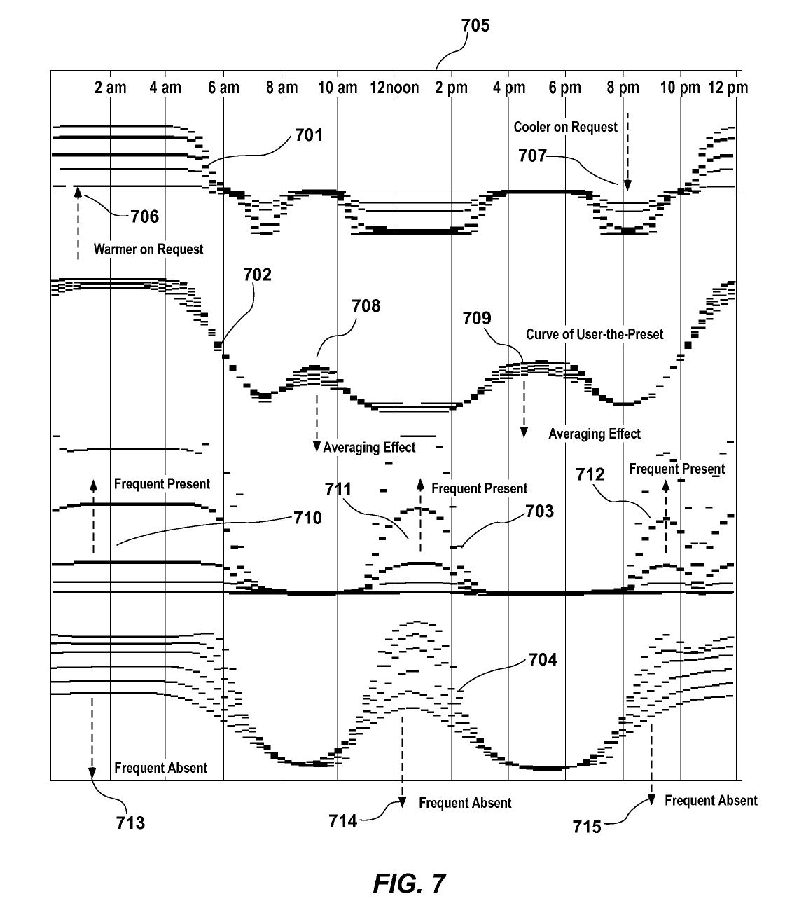

In order to understand the operation of how the curve, Level of Comfort, is to be adjusted daily, FIG. 7 curves (701 and 703) illustrate a view of an example of 6 continuous days adjustment in 24 hour based time-line (705), User provides response on level of his/her comfort, the curve reacts dynamically for necessary air cooling and circulation on demand, and curves (702 and 704) are another 6 days where User stops further demand, and the curve starts to equalize to a curve that balances the need of comfort and energy-saving. The curve (701) explains how Level of comfort curve changes on continuous request of warmer (706) and request of cooler (707), and later the curve (702) starts to equalize when without further request or feedback from user (708, 709). The curve (703) represents the user present, with continuous user present detected, curve goes up (710, 711, 712) indicating higher probability of user present at the same time slot. And similarly at curve (704), user continuous not present at the same time slot, indicating change of habit, and the figure goes down (713, 714, 715), to tell user will absent likely at the same time slot.

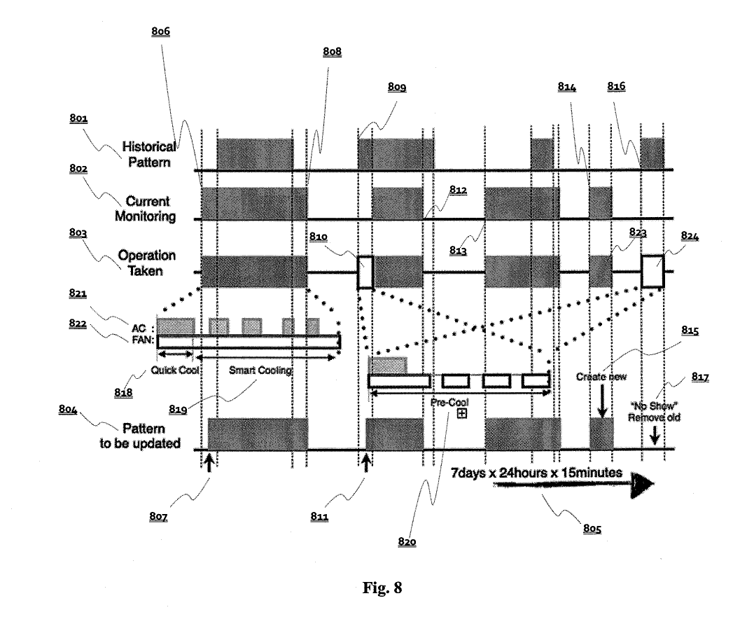

In illustration FIG. 8, it further explaining how the curve of Present, is to be used in the Invention. The patterns (801), (802) and (803) represent user should present based on accumulated occurrence, present detect status, and operation to be taken based on the result, respectively, in a-7 day record. The accumulated occurrence (801) takes the mentioned curve of Present(t), quantifies with the threshold of 68% of max (value of 16) to form Mark or Space. Similarly, user detect status is Mark if present, and Space if absent. The cases (806, 813) are that (802) is entered earlier than (801), system determines the delta of temperature and humidity, between the current measured and the curve level-of-comfort, and forms suitable PWM switching to external air conditioning devices, the air conditioner AC (821), and air circulation—FAN (822). The operation likes to have first 15 mins quick cool (818), following with a smart cooling (819, the calculated PWM switching operation—OpMode). With the previous mentioned equation, the pattern of Present (804) will be updated (807) as shown. The case (809) is that (802) is entered later than (801), again system determines the delta of temperature and humidity mentioned, provides necessary pre-cool (820) operation to the room and fmally updates the pattern (811). Similarly to (816), where the system treat that is “No show” (824, 817), hence the system only provides a maximum 15 mins of pre-cool (820) as ventilation for the room and stop, till user present or similar scenario of present. In the case (814), is that the present of user is totally new to the system, system treats this as a new element, and creates a new record for the time slot (815). System reacts this unexpected user present to the room, it determines the delta calculated, provides corresponding PWM switching control (823) to AC and FAN. The system does not learn user exit to the room, as long as user no longer at the target room (808, 812), the air conditioning will turn off automatically (45, 47).

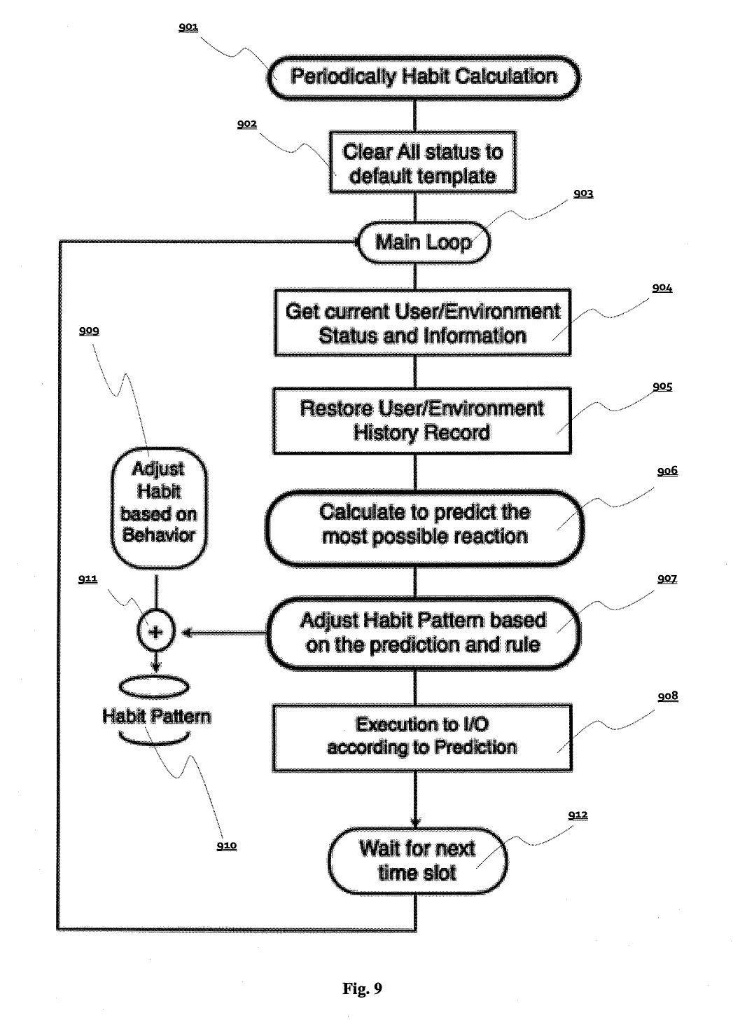

According to an embodiment of the invention, FIGS. 9, 10, 11, and 12 are the logic flow diagram, showing how the key state machine operated in a closed loop. To understand the flow diagram, it comprises: Periodically Habit Calculation and Instant Response to User Gesture.

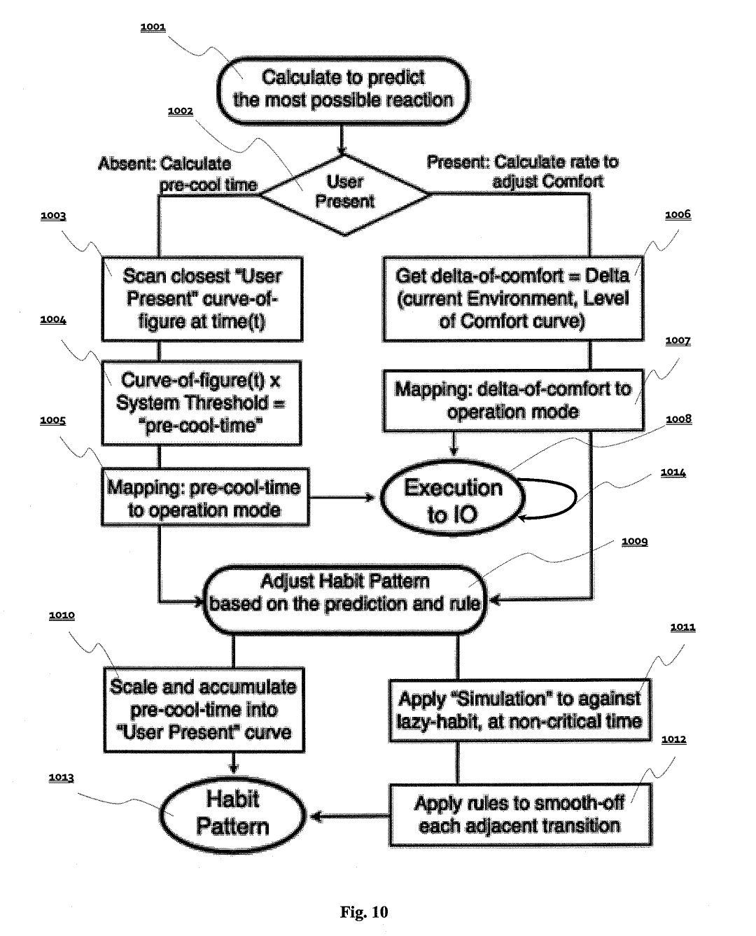

As name implied, the Periodically Habit Calculation (901) is executed periodically, and based on the sampled Environmental Information, uses predefine rules to support the predictive of calculation. Those Information includes climatic changes like the current temperature and humidity, the current User status of presence or absence, the history of all the record of temperature, humidity, comfort level, and the user in/out timing information. Some will be 24 hours based, and some will be 7 days based. In FIG. 9, illustrates the crucial functional block of the flow. With the power up, the system clear all status to factory status (902), then enter to the loop (903) self-operated on every 60 seconds (912), it fetches current user and environment status and information (904) and together with previous user history record (905), then computes and provides the best guess (906), commands the IO execution (908) for target intended action, Habit Pattern (910) here will be adjusted (911) based on the prediction and rule the system designed (907), and at the same time can be updated from user gesture (909). FIG. 10 provides an in-deep explanation of the decision making of prediction (1001), for the Air-conditioning application, user the Present (1002) will be a predominated factor to determine the need of air conditioning service, hence the logic first determines user Absent and Present status; in the case of Absence, system normally does not have to command external IO for any operation, unless the calculation shown, the current time slot nearby is very likely User will arrive or present (1003, 1004), necessary pre-air-circulation or cooling (1005) will be expected by User, then in this case the system commands external IO (1008) for air conditioning service. In the system we have the assumption that, suitable pre-air-circulation or cooling at the room is able to reduce the rate of high cool generation which is needed at the time user arrived. Right after the control to external IO, the indication of absent at time slot (t) feeds into the self-adjust mechanism (1010), so that the updated Habit Pattern (1013) can be used for next prediction.

For the case of user Present, it can be interpreted as user enters the room, or stays at the room. If user enters the room, the system bases on the delta of the current environment and the user level of comfort curve (1006), to determine necessary quick-cooling (1007), which is required to command the external IO (1008). If in the case user stays in the room, the current environment changes temporarily, and triggers the threshold, system calculates and commands external IO for necessary environment comfort adjustment. After that, the process goes into self-adjustment for Habit Pattern, which includes the mechanism—Stimulation (1011), which we previously mentioned to solve the mankind lazy-habit, and the Averaging (1012) which is to smoothen the control, avoid inefficiency switching.

In the Execution to IO (1008), there are rules to resolve conflict and few exceptions to make the system more humanity. (1014) shows this loopback, execute on every IO execution:
(i) High Temperature with Low Humidity but User feedback of too cold, it can be User health reason, and hence the system control will only take this as exception, allow temporary shut down the air cooling; and if it is needed shut down the air circulation, this operation will not adapt as feedback into Habit Pattern;
(ii) High Temperature with High Humidity but user feedback feel too cool, again may be Health reason, and hence the system control will only take this as exception, allow temporary shut down the air cooling; and if it is needed also shut down the air circulation, this operation will not adapt as feedback into Habit Pattern;
(iii) Low Temperature with Low Humidity but User feel still not cool enough, it can be too many Users crowded in the room, and hence the system control will only take this as exception, allow temporary turn the air cooling and air circulation ON fully, this operation will not adapt as feedback into Habit Pattern;
(iv) Low Temperature with High Humidity but User feel still not cool enough, it can be too many Users crowded in the room, and hence the system control will only take this as exception, allow temporary turn the air cooling and air circulation ON fully, this operation will not adapt as feedback into Habit Pattern;

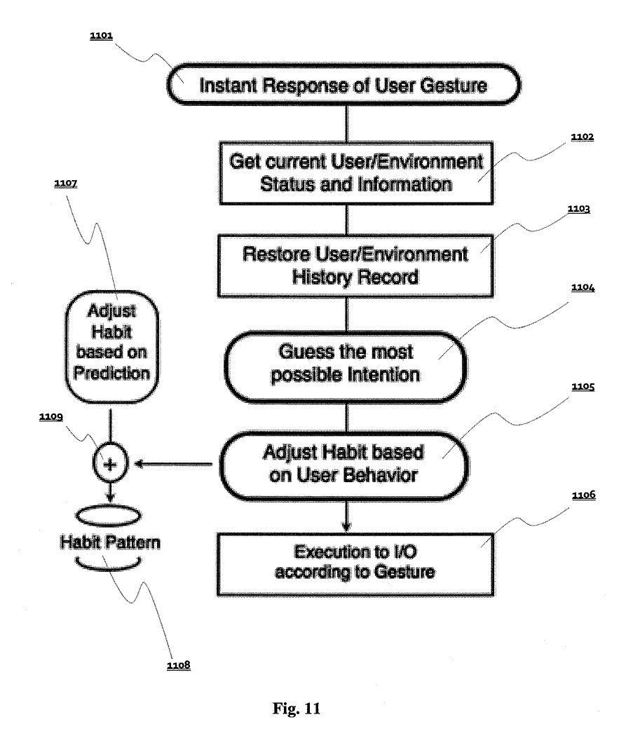

FIG. 11 illustrates a real-time response mechanism to user feedback—gesture (1101), which is similar to the previous Periodically Habit Calculation, fetches user and environment data (1102, 1103), calculates the most possible intention (1104), commands I/O (1106) and adjustment (1105, 1109) the Habit Pattern (1108). It allows a quick response to user, avoiding replicated request of service.

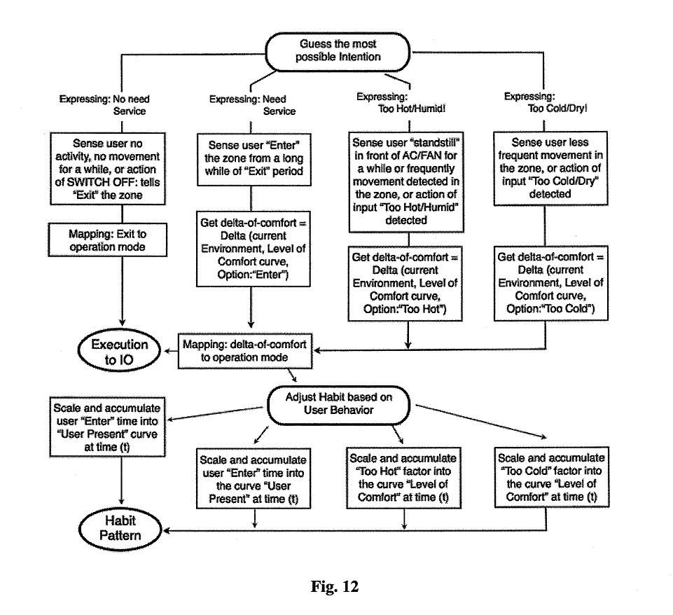

User gesture (1201) at FIG. 12, in the present Invention, we interpret ‘No need Service’ (1202), ‘Need Service’ (1204), ‘Too Hot/Humid’ (1206) and ‘Too Cold/Dry’ (1208), with following behavior:
No need air conditioning Service in this room (1202):
   ‘Sense no activity, body movement for a long while, or action to I/O like switch service off’
Need air conditioning Service in this room (1204):
   ‘Sense User activity, leverage between infrequent and frequent movement, or action to I/O like switch service on’
Too Hot or Humid in this room (1206):
   ‘Sense User present, come to standstill in front of AC/FAN, or high frequent movement at Bedroom Model’
Too Cold or Dry in this room (1208):
   ‘Sense User present, but less frequent movement, together with the mechanism of Stimulation’

After user being—the gesture is interpreted, the system anticipates the most possible intention of user being, by using environment data, previous level of comfort data and some rules for the guess. The intention will then map into an operation mode (1203, 1210), that commands the external IO (1211) to address the air conditioning need. Similarly to periodically calculation, the system also applies self-adjustment (1212) to adapt the latest User being and the Command executed, into the Habit Pattern (1217), so that to benefit for next estimation.

In the case of (1202), we treat user just exit the room, no service of air conditioning is required, the system stops all current PWM operation (1203); case (1204), we treat user just enter the room, service is required, the mapping is based on the delta of current environment and level of comfort (1205). If the delta well above specific threshold, highest PWM rating (OpMode=9) is mapped, otherwise the system maps linearly to PWM switching operation OpMode from 0 to 9.

In the case of (1206), the user expressing additional air cooling, the mapping is based on the delta of current environment and level of comfort and current OpMode ‘x’ (1207). If the delta well above specific threshold, highest PWM rating (OpMode=9) is mapped, otherwise the system maps linearly to PWM switching operation OpMode from ‘x’ to 9; Case of (1208), the user expressing over cool, the mapping is based on the delta of current environment and level of comfort and current OpMode ‘y’ (1209). If the delta well above specific threshold, air conditioning off (OpMode=0) is mapped, otherwise the system maps linearly to PWM switching operation OpMode from ‘y’ to 0;Adjustment in cases (1213), (1214), (1215) and (1216) follow the mentioned four-steps equation, to scale and accumulate commanded execution into the Habit Pattern.

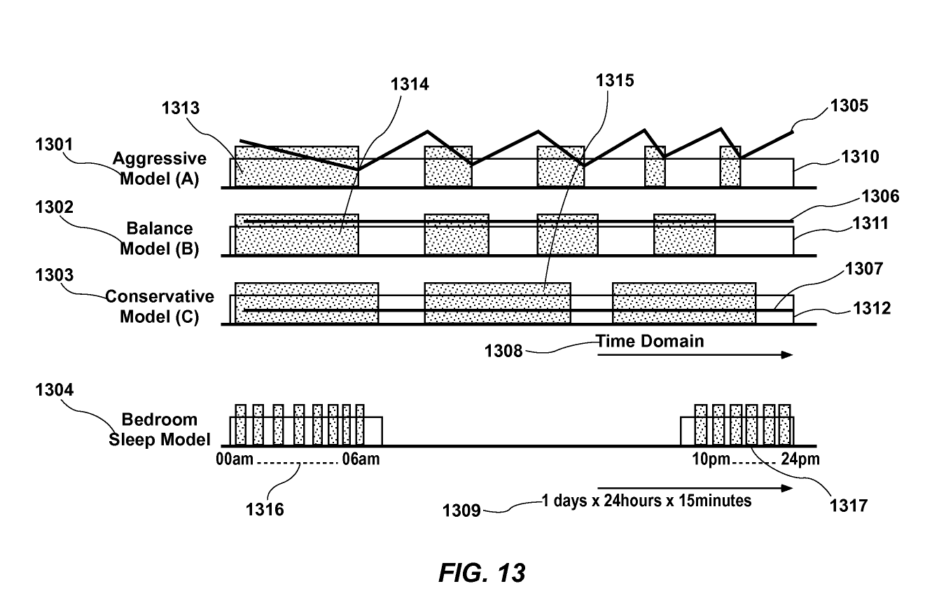

The system also allows few models as shown in FIG. 13, the Aggressive (1301), Balance (1302), Conservative (1303) and Bed-room (1304) usage. Conservative is kind of operation model to make best comfort as first priority, slightly over-cooled (1307), while Aggressive is the model for Energy saving as first priority which can be resulted, the room average temperature is slightly higher than User best comfort level (1305). Balance sits in between Aggressive and Conservative, weighting the Energy-Saving and the User-Comfort equally important (1306). User can base on their selection to force system running into different model of operation. Energy saving is based on the overall operation ratio between air-cooling (1313, 1314, 1315) and air-circulating (1310, 1311, 1312). The Bed-room model, which is a particular case for using the Invention at Bedroom, it is 24 hours basis (1309). When User is in sleep at Bed-room, which the PIR sensor may no longer be able to detect any movement from User and can mis-interpret user exits the room and turn the air-conditioning device off; with this model selected, the AC/FAN will have specific switching pattern and time schedule (1316, 1317) for User, and on detecting very frequent movement while sleeping, implying the room temperature is not cold enough, proper adjustment on air conditioning is required, resulting a cost effectively and comfort sleeping room.

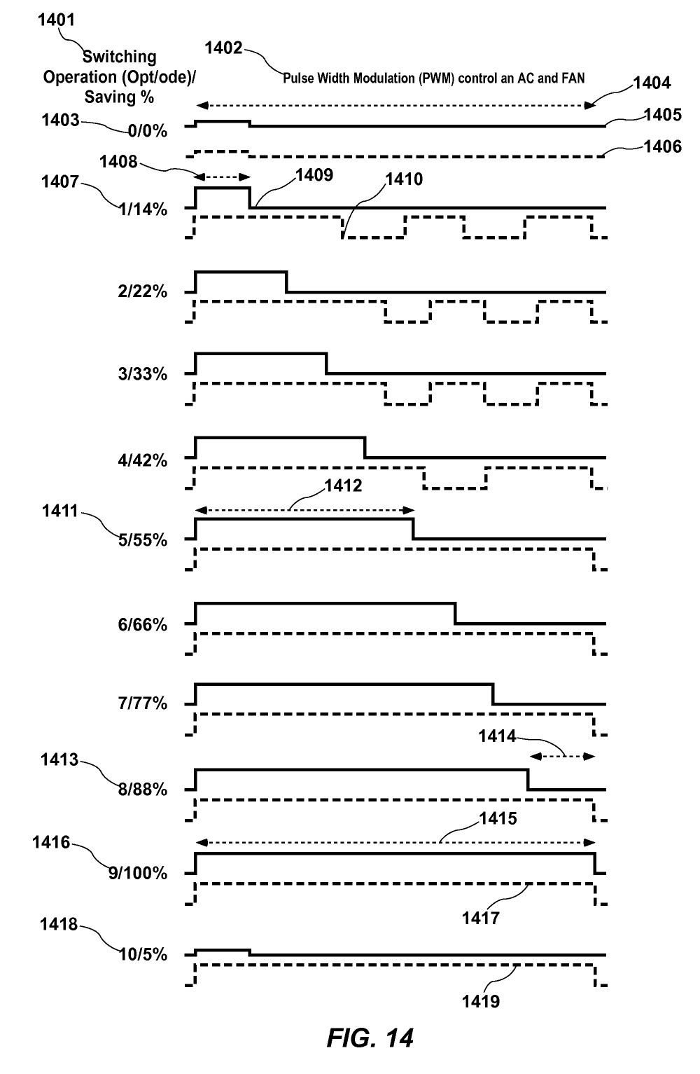

A fine table of switching operation (OpMode), a number (1401) of different pre-set PWM patterns (1402) are defined at FIG. 14, the percentage (%) indicates energy usage, 100% (1416) means AC and FAN (1417) always turn on, while 14% (1407) means 1/10 (1408) of time AC (1409) is on, and FAN (1410) will be turned on periodically for better circulation and best use of generated cool air for the room. To avoid switching the air conditioning unit too frequent and quick, the design pattern turn on the unit continuously at the first portion (1412), and off at the last portion (1414). And the designed pattern ensure three minutes of time for Pattern (1411) to wait before next switching on. OpMode equals 0 (1403) meaning turn off the air conditioning (1405) and circulating (1406) service off; and it is equals 10 (1418) meaning pre-cool or pre-air-circulation is selected, AC will be off while FAN (1419) will be on in the whole 15 mins time slot.

With the Invention, the indoor air conditioning is achieved via the use of existing AC, like Window-based in most residential usage, and an additional installed FAN for wide-spread air circulation zone providing effective way to blow off the hot air user surrounded. With the Habit Pattern, the control of the AC and the FAN are in switching mode, so that energy saving can be achieved via the loop back monitoring the temporal change of environment and user usage. Using the RTC, the Habit Pattern adapts the temporal changes of the environmental information and user status, the CPU takes SENSOR's input, like from Passive Infrared (PIR) based motion detectors for body movement, environment sensor for temperature and humidity changes, and the comfort level feedback. Based on all these inputs, the CPU anticipates with its knowledge, to provide its best switch control to SW, hence to AC and FAN, to adjust target air temperature.

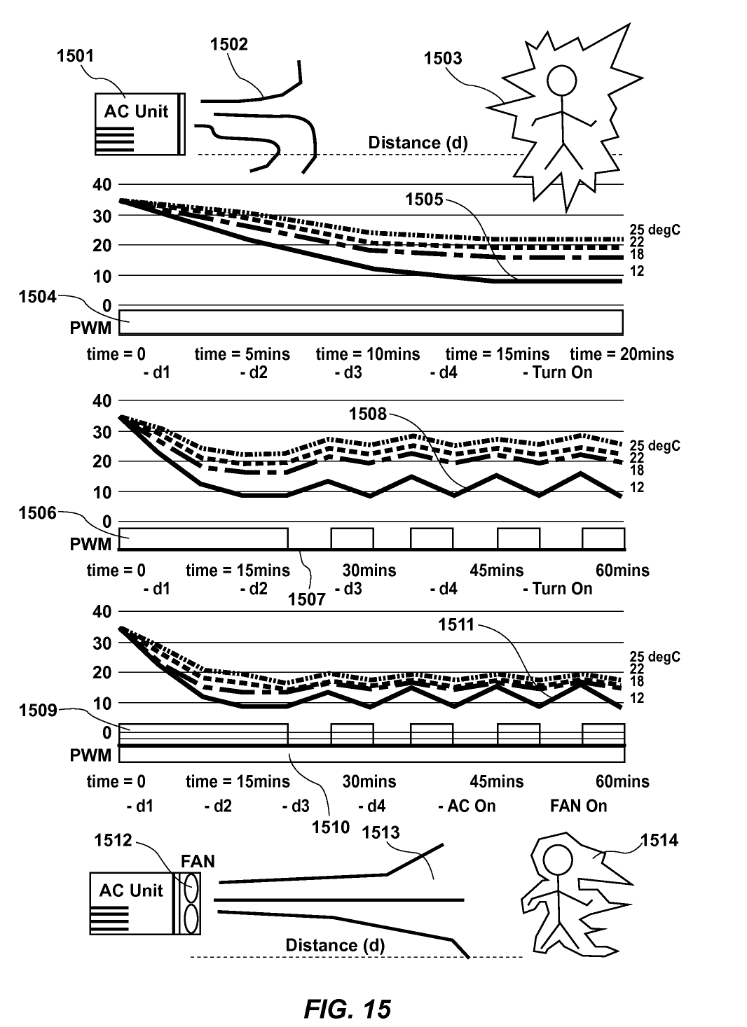

As shown in FIG. 15, traditionally air conditioning unit (1501) exchanges the indoor hot air with its freezing air, by using the local sensor to determine when is the time to turn on and off, its compressor, the device generate freezing air. However, because of the location of the sensor, and the sensitivity of switching logic are very rigid, making the target air conditioning room is either too cool or not cool enough. Like the illustration in FIG. 15 is a traditional AC unit (1501), the User (1503, 1514) acts as a hot source, most AC controls its compressor all ON as (1504) and resulting the temperature distribution with respect to distance, it is found that temperature will be very stable eventually and maintain at very good cooling stage after awhile. However, because of the short circulation loop (1502), the temperature difference against distance will be huge (1505), making the region close to the AC too cool in order to maintain far-end of the zone cool enough; also the energy saving is nil as the compressor is required to turn on (1504) all the way till the user at far-end feels comfort. According to our invention, an additional FAN (1512) and device switching (30,32,33) are used to wide-spread the cooled air circulation (1513) and to modulate the time for existing AC ‘switch ON’ (1506, 1509) and the FAN ‘switch ON’ (1507, 1510). It results the air conditioning, faster to reach the User comfort level, widespread the cooled air to reduce the temperature gap (1508, 1507) and significant to save energy.

FIG. 16 is a closer scope of the effect from the benefit extending the Air Circulation Zone (ACZ). Before using the Invention, the AC intake hot air (1602) in one side and blow cool air (1601) on the other side, they are physically close together and because of the design framework, local air feedback is easily happened, making the cool air circulation zone (ACZ) small (1603). User, the hot object (1604) feeling hot is because of the hot air enveloping himself, it is changed until the room temperature nearby user brings down to absorb the heat of this envelop, or user walk into the ACZ (1603), so as to blow away the heat envelop.

With the invention, the AC separates the hot air intake (1608) and cool air outlet (1605) path, more directional, by different design framework (1607), not only it reduces the chance of local feedback, but also the powerful Fan makes the cool air (1606) flow longer distance; resulting the ACZ (1609) wide in range, more quickly to reach the user and blow off the hot envelop (1610). It is an important factor making the switch modulated AC/FAN still meet User's level of comfort while having significant energy saving. Also, to provide more realistic environmental figure, the SENSOR, temperature and humidity sensors will be placed at a location where is close to user activity zone, via wired or wireless (RF) network. The CPU knowledge is initially from a template built-in, by then User and Environmental changes will be recorded in CPU memory, and naturally adapts as Habit Pattern for its intelligent guess to AC and FAN switch control. User feedback can be via those input, like senor or key address Level of Comfort adjustment.

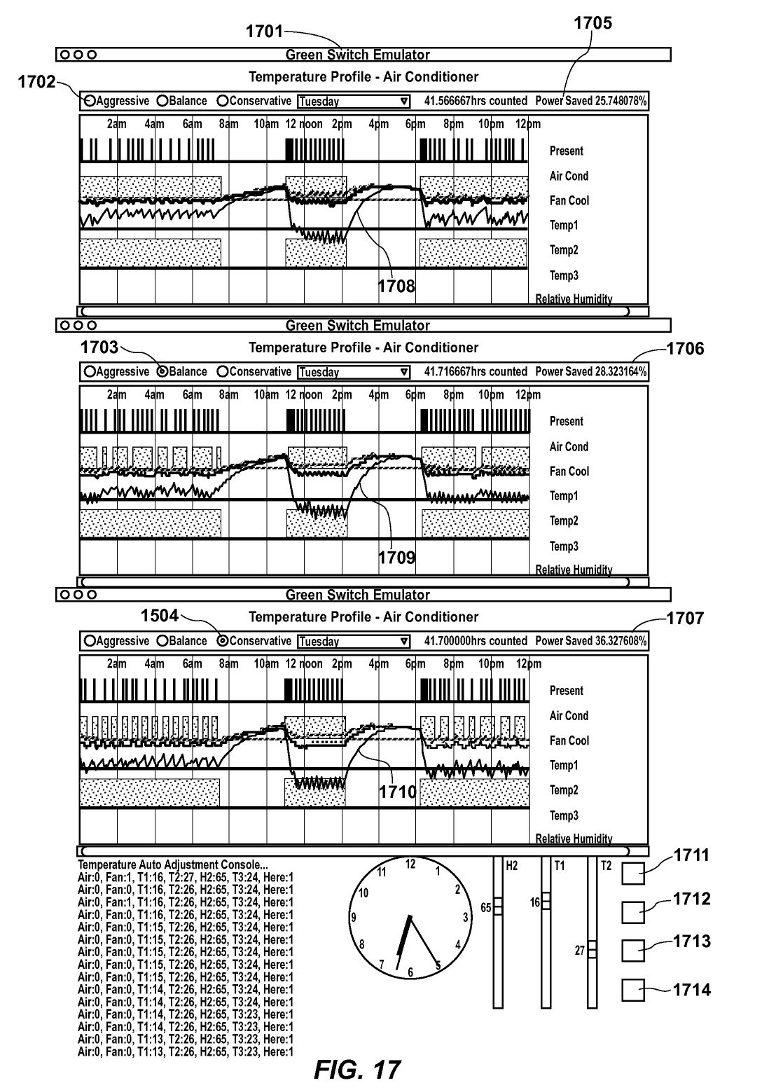

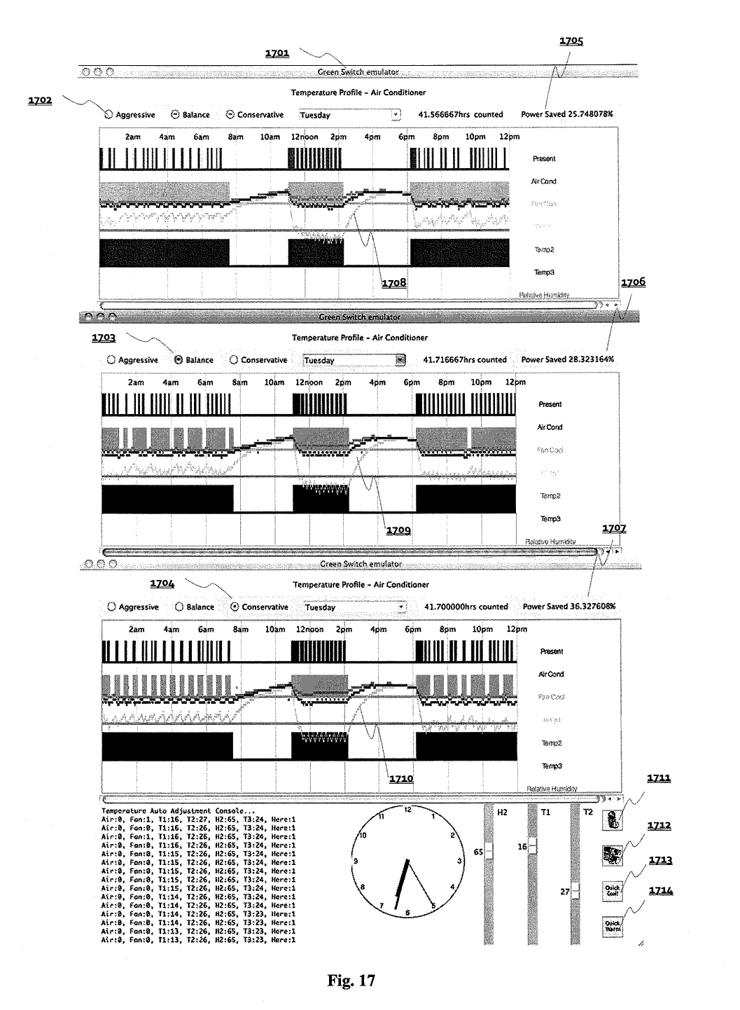

FIG. 17 shows stimulation result of an exemplifying situation, generated from the software (1701) captured the week of operation, the switches modulation for AC and FAN, the temperature captured closest to AC, the closest temperature and humidity measured from User, and the average temperature reading. The curve shows a stable air conditioning can be achieved even with lower % of AC turn on time. In result of Aggressive (1702), although the resultant room temperature is relatively higher and fluctuate (1708), it gives best power saving (1705), and in the result of conservative (1704), the curve gives relative too low in temperature than required (1710), and also gives least of energy saving (1707). Model of Balance, it gives relative better stable in temperature and meet the expected requirement, and also its energy saving is also very low compare with other two models. In the software, there are few more buttons available for the emulation, the control of force-present (1711), the selection of bedroom (1712), the force feedback of too hot (1713) and the force feedback of too cold (1714).

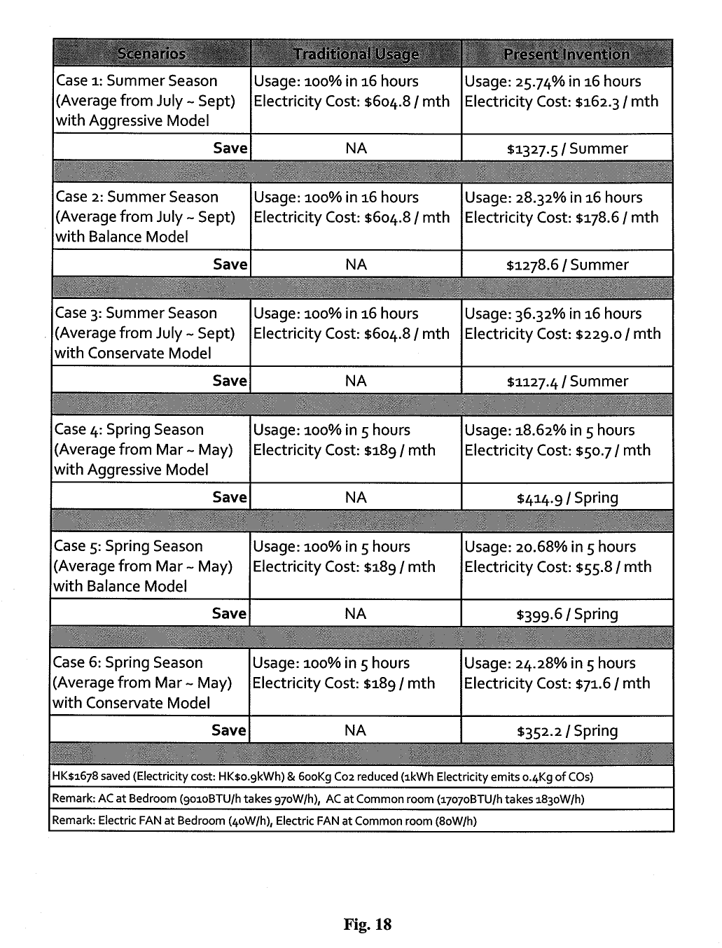

FIG. 18 shows the recorded time measured and the corresponding energy saved during the test period, and shows the forecast of a mouth, a year of time of saving. From the stimulation, forecast, a range of HKS350˜1300 can be achieved in three months, approximate HK$1678 can be saved, 600 Kg Co2 can be reduced per year.

### INDUSTRIAL APPLICABILITY

The embodiments and arrangements described hereinafter are applicable to electrical, air conditioning, and lighting industries, amongst others.

The foregoing description provides exemplary embodiments only, and is not intended to limit the scope, applicability or configurations of the present invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

The term “comprising”, as used herein, is intended to have an open-ended, non-exclusive meaning. For example, the term is intended to mean: “including principally, but not necessarily solely” and not to mean “consisting essentially of” or “consisting only of”. Variations of the term “comprising”, such as “comprise”, “comprises” and “is comprised of”, have corresponding meanings.

We claim:

1. A method for habit oriented control in electrical systems, comprising the steps of:
generating a temporal habit pattern, based on past environmental parameters captured by sensors, past user feedback input from user interface or past user commands input from user interface;
storing said temporal habit pattern;
comparing said temporal habit pattern against current environmental parameters captured by sensors or current user feedback input from user interface; and
determining the driving of an electrical system to optimize energy saving based on the deviation of current user status and current environmental parameters from said temporal habit pattern.
wherein generating a temporal habit pattern further comprises the step of challenging user habit by tuning said temporal habit pattern to values for which the electrical system consumes less energy.

2. The method for habit oriented control in electrical systems according to claim 1, wherein generating a temporal habit pattern further comprises the steps of:
initializing said temporal habit pattern based on default values;
updating the values of said temporal habit pattern to align with user feedback or user commands on a periodic basis.

3. The method for habit oriented control in electrical systems according to claim 2, wherein generating a temporal habit pattern further comprises the step of equalizing the values of said temporal habit pattern by averaging adjacent values in the time domain of said temporal habit pattern.

4. The method for habit oriented control in electrical systems according to claim 2, wherein said temporal habit pattern represents the presence of user before said electrical system.

5. The method for habit oriented control in electrical systems according to claim 4, wherein said default value ranges from 0 to 16;wherein said updating the values of said temporal habit pattern is carried out by the equation:
Present(t)=Present′(t)*Pscale+Poffset
where Present(t) represents the presence of user at time slot t and ranges from 0 to 16;
Present′(t) represents the historical presence of user at time slot t and ranges from 0 to 16;
Pscale represents the scaling factor which ranges from 1 to 2 if user is present at time slot t, and ranges from 0 to 1 if user is absent at time slot t;
Poffset represents the offset value which ranges from 0 to 16 if user is present at time slot t, and ranges from 0 to 1 if user is absent at time slot t.

6. The method for habit oriented control in electrical systems according to claim 3, wherein said temporal habit pattern represents the presence of user before said electrical system, and wherein said equalizing the values of said temporal habit pattern is carried out by the equation:
Present(t)=Present′(t−1)*scale1+Present′(t)*scale2+Present′(t+1)*scale3+offset
where Present(t) represents the presence of user at time slot t and ranges from 0 to 16;
Present′(t) represents the historical presence of user at time slot t and ranges from 0 to 16;
scale1, scale2, scale3 range from 0.01 to 0.99;
offset ranges from 0.01 to 10.

7. The method for habit oriented control in electrical systems according to claim 1, wherein said electrical system is an air-conditioning system, and wherein said temporal habit pattern represents the temperature level of comfort.

8. The method for habit oriented control in electrical systems according to claim 7, wherein said default value ranges from 20 to 35; and wherein said updating the values of said temporal habit pattern is carried out by the equation:
LOC_{—}t(t)=LOC_{—}t′(t)*Tscale+Toffset
where LOC_t(t) represents the temperature level of comfort at time slot t and ranges from 20 to 35;
LOC_t′(t) represents the historical temperature level of comfort at time slot t and ranges from 20 to 35;
Tscale represents the scaling factor which ranges from 0.5 to 1.9;
Toffset represents the offset value which ranges from +0.1 to +0.9 if user feedbacks too cold at time slot t, and ranges from −0.1 to −0.9 if user feedbacks too hot at time slot t.

9. The method for habit oriented control in electrical systems according to claim 7, wherein said challenging user habit further comprises the steps of:
determining the minimum value Lm of the temperature level of comfort curve LOC_t′(t);
marking up values in temperature level of comfort curve which are less than (Lm*Mscale1) for at least 4 continuous values; and
replacing the marked up values in said temperature level of comfort curve by applying the equation:
LOC_{—}t(t)=LOC_{—}t′(t)*Mscale
where Mscale and Mscale1 range from 0.1 to 1.9.

10. The method for habit oriented control in electrical systems according to claim 3, wherein said electrical system is an air-conditioning system, wherein said temporal habit pattern represents the temperature level of comfort, and wherein said equalizing the values of said temporal habit pattern is carried out by the equation:
LOC_{—}t(t)=LOC_{—}t′(t−1)*scale1+LOC_{—}t′(t)*scale2+LOC_{—}t′(t+1)*scale3+offset
where LOC_t(t) represents the temperature level of comfort at time slot t and ranges from 20 to 35;
LOC_t(t) represents the historical temperature level of comfort at time slot t and ranges from 20 to 35;
scale1, scale2, scale3 range from 0.01 to 0.99;
offset ranges from 0.01 to 10.

11. The method for habit oriented control in electrical systems according to claim 1, wherein said electrical system is an air-conditioning system, and wherein said temporal habit pattern represents the humidity level of comfort.

12. The method for habit oriented control in electrical systems according to claim 11, wherein said default value ranges from 46 to 98; and wherein said updating the values of said temporal habit pattern is carried out by the equation:
LOC_{—}h(t)=LOC_{—}h′(t)*Hscale+Hoffset
where LOC_h(t) represents the humidity level of comfort at time slot t and ranges from 46 to 98;
LOC_h′(t) represents the historical humidity level of comfort at time slot t and ranges from 46 to 98;
Hscale represents the scaling factor which ranges from 0.5 to 1.9;
Hoffset represents the offset value which ranges from +1 to +9 if LOC′t(t)<20 and user feedbacks too cold at time slot t, and ranges from −1 to −9 if user feedbacks too hot at time slot t.

13. The method for habit oriented control in electrical systems according to claim 3, wherein said electrical system is an air-conditioning system, wherein said temporal habit pattern represents the humidity level of comfort, and wherein said equalizing the values of said temporal habit pattern is carried out by the equation:
LOC_{—}h(t)=LOC_{—}h′(t−1)*scale1+LOC_{—}h′(t)*scale2+LOC_{—}h′(t+1)*scale3+offset
where LOC_h(t) represents the humidity level of comfort at time slot t and ranges from 46 to 98;
LOC_h′(t) represents the historical humidity level of comfort at time slot t and ranges from 46 to 98;
scale1, scale2, scale3 range from 0.01 to 0.99;
offset ranges from 0.01 to 10.

14. The method for habit oriented control in electrical systems according to claim 1, wherein the driving of said electrical system is performed by various modes of switch modulation.

15. The method for habit oriented control in electrical systems according to claims 1, further comprising the step of displaying information of energy saving with respect to the usage of said electrical system.

16. The method for habit oriented control in electrical systems according to claims 1, wherein said sensors are arranged at one or more locations, and are in communication with said electrical system via wired or wireless connections.

17. The method for habit oriented control in electrical systems according to claims 1, wherein said user feedback input comprises sensor input in response to the user being present before said sensor for predetermined period of time, indicating positive user request of service from said electrical system.

18. The method for habit oriented control in electrical systems according to claims 1, wherein said electrical system is a lighting system, and wherein said environmental parameters are selected from the group comprising illumination condition with respect to time and location.

19. The method for habit oriented control in electrical systems according to claims 18, wherein the temporal habit pattern represents user activities with respect to different time and different day of the week, and wherein said driving of said lighting system provides required level of illumination and optimizes energy saving.
